(19) United States
(12) Patent Application Publication
(10) Pub. No.: US 2022/0009661 A1
(43) Pub. Date: Jan. 13, 2022

(54) Beverage Brewing Cartridge, Cartridge Construction Kit, and Method of Constructing a Beverage Cartridge

(71) Applicant: Adrian Rivera, Whittier, CA (US)

(72) Inventor: Adrian Rivera, Whittier, CA (US)

(21) Appl. No.: 17/213,002

(22) Filed: Mar. 25, 2021

Related U.S. Application Data
(63) Continuation-in-part of application No. 15/286,845, filed on Oct. 6, 2016, now Pat. No. 11,021,284.
Application No. 15/286,845 is a continuation-in-part of application No. 15/187,444, filed on Jun. 20, 2016, now Pat. No. 9,586,709.
Application No. 15/187,444 is a continuation-in-part of application No. 15/256,929, filed on Sep. 6, 2016, now Pat. No. 10,912,407.

(51) Int. Cl. B65B 29/02; B65D 85/804; B65B 1/24; B65B 7/28

(52) U.S. Cl. CPC B65B 29/022; B65B 7/2821; B65B 1/24; B65D 85/8052

(57) ABSTRACT

A beverage brewing cartridge includes a base and a plug. The base includes a sidewall, a fillable end having an opening, and a closed end. The plug is configured to close off the opening. A method of constructing a brewing cartridge includes placing the base of the beverage brewing cartridge on a cartridge seat of a cartridge tool with the closed end against the cartridge seat. A cartridge lock retains the base against the cartridge tool. A portion of brewing material is scooped and poured into the base through a mouth of the cartridge lock and the opening of the fillable end of the base, and then tamped into the base. The plug is positioned above and aligned with the opening of the fillable end of the base, and seated into the opening to close the opening, thereby completing construction of the brewing cartridge.

### CROSS-REFERENCE TO RELATED APPLICATIONS

This is a Continuation-In-Part of co-pending U.S. patent application Ser. No. 15/286,845, which was filed on Oct. 6, 2016; which in turn is a Continuation-In-Part of U.S. patent application Ser. No. 15/187,444, which was filed on Jun. 20, 2016, and a Continuation-In-Part of U.S. patent application Ser. No. 15/256,929, which was filed on Sep. 6, 2016, the entire disclosures of which are incorporated herein in their entireties.

### FIELD OF THE INVENTION

The invention relates to brewed beverages and in particular to beverage brewing cartridges, methods of making beverage brewing cartridges, and tools for making beverage brewing cartridges.

### BACKGROUND OF THE INVENTION

Beverage brewing cartridges typically contain ground brewing material, through which water is flowed to brew a beverage. For example, espresso beverages are made by forcing high-pressure water through tightly packed, finely ground coffee. The ground coffee is contained in a holder commonly called a “portafilter”, or into a pre-packaged espresso cartridge. High-pressure water is forced through the ground coffee and beverage is extracted in small, concentrated amounts. Many espresso drinkers prefer the simplicity of using the espresso cartridges, but are limited in the selection of ground coffee to varieties available in the pre-packaged espresso cartridges, and the cost of brewing beverages from disposable, individual cartridge is great, both economically and in terms of impact on the environment.

### BRIEF SUMMARY OF THE INVENTION

According to an aspect of the invention, a beverage brewing cartridge includes a cartridge base, and a cartridge plug. The cartridge base includes a sidewall, a fillable end having an opening, and a closed end. The cartridge plug is configured to close off the opening of the fillable end of the cartridge base. The cartridge base sidewall can be, for example, frustoconical in shape. The closed end of the cartridge base can be sealed, for example, with foil. The cartridge plug can include ports configured to allow fluid to flow from the cartridge. For example, the ports can include weakened areas configured to burst under pressure, thereby allowing fluid to flow from the cartridge. The cartridge plug or the opening of the fillable end of the cartridge base can include an annular recess, and the other can include a corresponding annular ridge, configured for mutual mating contact. The beverage brewing cartridge can also include a circumferential lip above the annular recess. The circumferential lip can include gaps configured to allow the circumferential lip to collapse during insertion of the cartridge plug into the opening of the fillable end of the cartridge base.

According to another aspect of the invention, a method of constructing a brewing cartridge includes placing the cartridge base of the beverage brewing cartridge on a cartridge seat of a cartridge tool with the closed end of the cartridge base against the cartridge seat. The cartridge base is retained against the cartridge tool using a cartridge lock. A portion of brewing material is scooped and poured into the cartridge base through a mouth of the cartridge lock and the opening of the fillable end of the cartridge base. The brewing material is then tamped into the cartridge base. The cartridge plug is positioned above and aligned with the opening of the fillable end of the cartridge base. The cartridge plug is then seated into the opening of the fillable end of the cartridge base to close the opening of the fillable end of the cartridge base, thereby completing construction of the brewing cartridge. The method can also include releasing the cartridge lock from the cartridge base, and removing the brewing cartridge from the cartridge tool.

Scooping the portion of brewing material and tamping the brewing material into the cartridge base can include using a combination scooping/tamping tool. The method can also include leveling the portion of brewing material using a leveling arm of the combination scooping/tamping tool, prior to pouring the scooped brewing material.

Positioning the cartridge plug above and aligned with the opening of the fillable end of the cartridge base can include engaging a first guide element on the cartridge plug with a second guide element on an end of the combination scooping/tamping tool, and inserting the end of the combination scooping/tamping tool into an access mouth of the cartridge lock.

The method can also include, prior to placing the cartridge base on the cartridge seat of the cartridge tool, obtaining the cartridge base, and sealing an end of the cartridge base to form the closed end of the brewing cartridge base. For example, sealing the end of the cartridge base can include applying foil to the end of the brewing cartridge base. Seating the cartridge plug into the opening of the fillable end of the cartridge base can include engaging a ridge into a recess.

According to another aspect of the invention, a beverage brewing cartridge construction kit, configured to construct a brewing cartridge, includes the cartridge tool and the cartridge lock. The cartridge tool can include a cartridge seat. The beverage brewing cartridge construction kit can also include a combination scooping/tamping tool. The combination scooping/tamping tool can include a levelling arm and/or a cartridge plug guide element.

### BRIEF DESCRIPTION OF THE DRAWINGS

FIG. 1 shows a bottom isometric view of an exemplary cartridge according to the invention.

FIG. 2A shows a top isometric view of an exemplary cartridge according to the invention with the cartridge base top open.

FIG. 2B shows a top isometric view of an exemplary cartridge according to the invention with the cartridge base top closed.

FIG. 3A shows a side view of an exemplary cartridge according to the invention.

FIG. 3B shows a top view of an exemplary cartridge according to the invention.

FIG. 3C shows a bottom view of an exemplary cartridge according to the invention.

FIG. 4 shows a cross-sectional view of an exemplary cartridge according to the invention taken along line 4-4 of FIG. 3A.

FIG. 5 shows a top isometric view of an exemplary cartridge base according to the invention.

FIG. 6 shows a bottom isometric view of an exemplary cartridge base according to the invention.

FIG. 7A shows a side view of an exemplary cartridge base according to the invention.

FIG. 7B shows a top view of an exemplary cartridge base according to the invention.

FIG. 7C shows a bottom view of an exemplary cartridge base according to the invention.

FIG. 8 shows a cross-sectional view of an exemplary cartridge base according to the invention taken along line 8-8 of FIG. 7A.

FIG. 9A shows a side view of an exemplary bottom plug according to the invention.

FIG. 9B shows a top view of an exemplary bottom plug according to the invention.

FIG. 9C shows a bottom view of an exemplary bottom plug according to the invention.

FIG. 10 shows a cross-sectional view of an exemplary bottom plug according to the invention taken along line 10-10 of FIG. 9A.

FIG. 11 shows a detailed top isometric view of an exemplary bottom plug according to the invention.

FIG. 12 shows a detailed cross-sectional view of an exemplary bottom plug according to the invention taken along line 10-10 of FIG. 9A.

FIG. 13 shows a detailed bottom isometric view of an exemplary bottom plug according to the invention.

FIG. 14A shows a first isometric view of an exemplary hand-held tool according to the invention.

FIG. 14B shows a second isometric view of an exemplary hand-held tool according to the invention.

FIG. 14C shows a third isometric view of an exemplary hand-held tool according to the invention.

FIG. 14D shows a fourth isometric view of an exemplary hand-held tool according to the invention.

FIG. 15 shows an isometric view of an exemplary frame of a hand-held tool according to the invention.

FIG. 16A shows a side view of an exemplary frame of a hand-held tool according to the invention.

FIG. 16B shows a top view of an exemplary frame of a hand-held tool according to the invention.

FIG. 16C shows a bottom view of an exemplary frame of a hand-held tool according to the invention.

FIG. 16D shows a rear view of an exemplary frame of a hand-held tool according to the invention.

FIG. 16E shows a front view of an exemplary frame of a hand-held tool according to the invention.

FIG. 17 A shows a first isometric view of an exemplary tamper/seater of a hand-held tool according to the invention.

FIG. 17B shows a second isometric view of an exemplary tamper/seater of a hand-held tool according to the invention.

FIG. 18A shows a side view of an exemplary tamper/seater of a hand-held tool according to the invention.

FIG. 18B shows a rear view of an exemplary tamper/seater of a hand-held tool according to the invention.

FIG. 19A shows a first isometric view of an exemplary countertop tool according to the invention.

FIG. 19B shows a second isometric view of an exemplary countertop tool according to the invention.

FIG. 20A shows an exemplary tool base of a countertop tool according to the invention.

FIG. 20B shows a second view of an exemplary tool base of a countertop tool according to the invention.

FIG. 20C shows an exemplary tool base of a countertop tool according to the invention with an exemplary cartridge lock according to the invention attached to a tool base.

FIG. 21A shows a side view of an exemplary funnel according to the invention.

FIG. 21 B shows an isometric view of an exemplary funnel according to the invention.

FIG. 21 C shows a top view of an exemplary funnel according to the invention.

FIG. 21 D shows a bottom view of an exemplary funnel according to the invention.

FIG. 22 shows an isometric view of an exemplary cartridge lock according to the invention.

FIG. 23A shows a side view of an exemplary cartridge lock according to the invention.

FIG. 23B shows a side view of an exemplary cartridge lock according to the invention, rotated 90 degrees.

FIG. 23C shows a top view of an exemplary cartridge lock according to the invention.

FIG. 23D shows a bottom view of an exemplary cartridge lock according to the invention.

FIG. 24 shows a cross-sectional view of an exemplary cartridge lock according to the invention taken along line 24-24 of FIG. 23C.

FIG. 25A shows an exemplary scoop and tamper tool according to the invention with an exemplary retracted leveling fork according to the invention.

FIG. 25B shows an exemplary scoop and tamper tool according to the invention with an exemplary extended leveling fork according to the invention.

FIG. 26 shows an isometric view of an exemplary leveling fork according to the invention.

FIG. 27A shows a side view of an exemplary scoop and tamper tool according to the invention with an exemplary retracted leveling fork according to the invention.

FIG. 27B shows a top view of an exemplary scoop and tamper tool according to the invention with an exemplary retracted leveling fork according to the invention.

FIG. 28A shows a side view of an exemplary scoop and tamper tool according to the invention with an exemplary extended leveling fork according to the invention.

FIG. 28B shows a top view of an exemplary scoop and tamper tool according to the invention with an exemplary extended leveling fork according to the invention.

FIG. 29 shows an isometric view of an exemplary seating tool according to the invention.

FIG. 30A shows a side view of an exemplary seating tool according to the invention.

FIG. 30B shows a bottom view of an exemplary seating tool according to the invention.

FIG. 31 shows a side view of an exemplary hand-held tool according to the invention, in an open state.

FIG. 32 shows a side view of an exemplary hand-held tool according to the invention, in a closing state.

FIG. 33 is a flow diagram of an exemplary method according to the invention for using a hand-held tool.

FIG. 34 is a flow diagram of an exemplary method according to the invention for using a table-top tool.

FIG. 35A shows a top/quarter isometric view of an exemplary countertop tool according to the invention.

FIG. 35B shows a bottom/quarter isometric view of an exemplary countertop tool according to the invention.

FIG. 36A shows a top/side isometric view of an exemplary scoop/tamper/seating tool according to the invention.

FIG. 36B shows a bottom/side isometric view of an exemplary scoop/tamper/seating tool according to the invention.

FIG. 36C shows a top/rear isometric view of an exemplary scoop/tamper/seating tool according to the invention.

FIG. 37 A shows a top/rear isometric view of an exemplary scoop/tamper/seating tool according to the invention, with a retracted sliding level.

FIG. 37B shows a top/rear isometric view of an exemplary scoop/tamper/seating tool according to the invention, with a partially extended sliding level.

FIG. 37C shows a top/rear isometric view of an exemplary scoop/tamper/seating tool according to the invention, with a fully extended sliding level.

FIG. 38 shows an exemplary scoop/tamper/seating tool according to the invention, releasing brewing material into an espresso cartridge retained in a tool base.

FIG. 39 shows an exemplary scoop/tamper/seating tool according to the invention positioned to tamp brewing material in an espresso cartridge retained in a tool base.

FIG. 40 shows an exemplary scoop/tamper/seating tool according to the invention positioned to seat a bottom plug in an espresso cartridge retained in a tool base.

Corresponding reference characters indicate corresponding components throughout the several views of the drawings.

### DETAILED DESCRIPTION OF THE INVENTION

The following description includes the best mode presently contemplated for carrying out the invention. This description is not to be taken in a limiting sense. The scope of the invention should be determined with reference to the claims. Further, the terms “top” and “bottom” are used in the description, but only for ease of explanation with respect to orientation in the drawings. These terms do not restrict any relative orientation of components of the invention, which is contemplated to cover any such orientation.

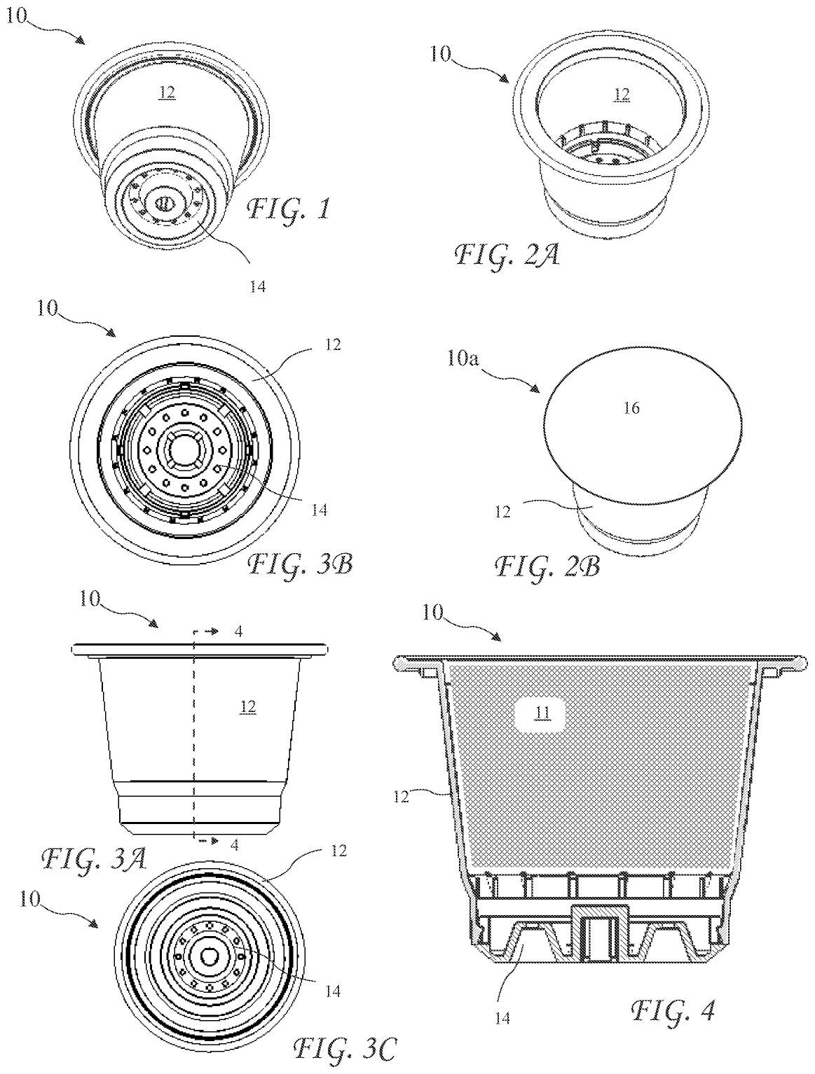

Referring to FIGS. 1-4, an espresso cartridge is described as an exemplary beverage cartridge according to the invention. The cartridge 10 is configured to be at least partially filled with ground beverage brewing material, in this case coffee beans ground for brewing espresso. The cartridge 10 includes cartridge base top 12a and a cartridge base bottom 12b.

The cartridge base top 12a can be provided with the cartridge base top 12a open, or can be covered or otherwise closed, such as with foil material 16 or the like sealing the cartridge base top 12a. When the cartridge is provided with the cartridge base top 12a open, the foil material 16 or other cover can be attached to the cartridge base 12 before filling the cartridge base with brewing material. A bottom plug 14 is inserted into the cartridge base 12 after filling the cartridge base 12 through an open cartridge base bottom 12b (see FIG. 8), or an opening in the cartridge base bottom 12b.

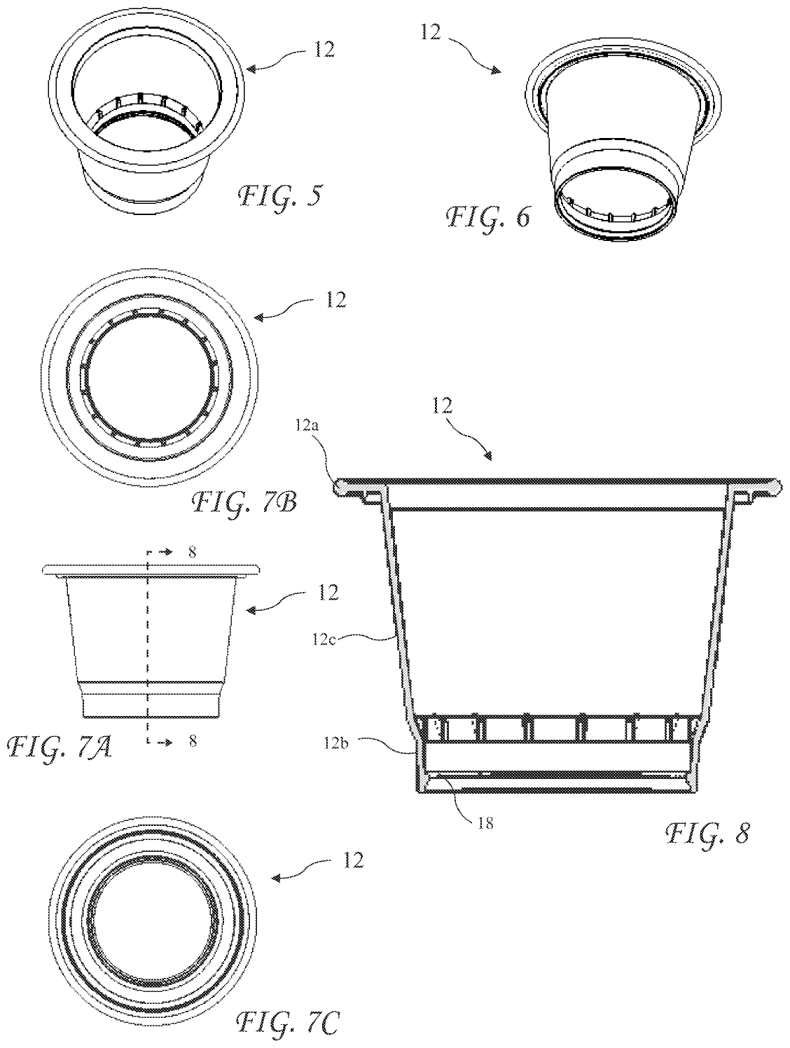

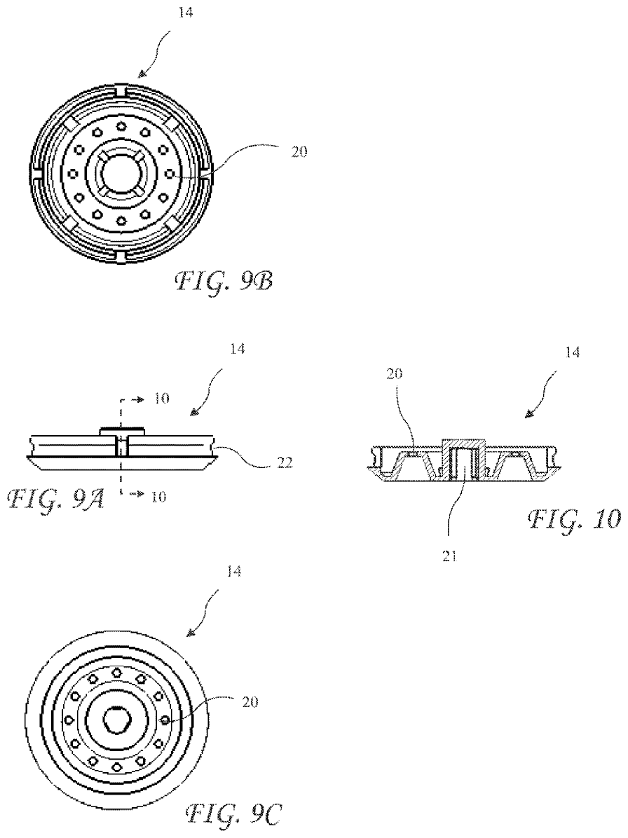

Referring to FIGS. 5-8, the cartridge base 12 includes the base top 12a, the open base bottom 12b, and, in this exemplary embodiment, frustoconical shaped walls 12c, although the sidewall 12c can take any feasible shape or outline. As shown, if the sidewall 12c is frustoconical in shape, the base bottom 12b has a smaller diameter than the base top 12a. An interior annular ridge 18 in the base bottom 12b engages an exterior annular recess 22 (see FIG. 9A) in the bottom plug 14 to retain the bottom plug 14 in the base bottom 12b, although in alternative embodiments the ridge 18 and the recess 22 can be swapped between these two components.

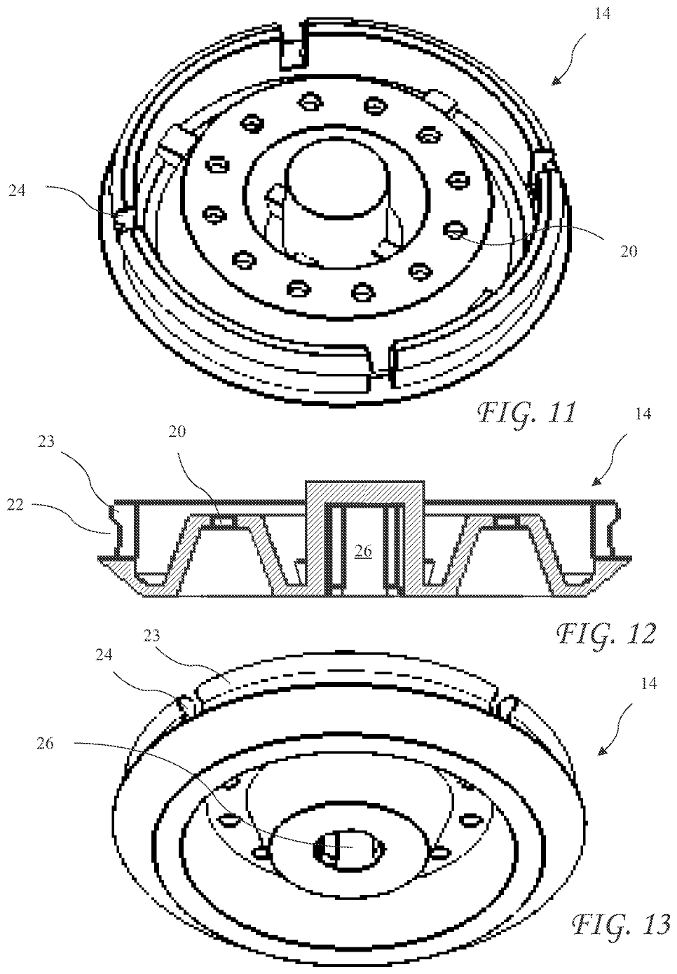

Referring to FIGS. 9A-13, the bottom plug 14 defines the exterior annular recess 22 created by a lip 23 above the exterior annular recess 22. The lip 23 includes gaps 24 that allow the lip 24 to slightly distort when the bottom plug 14 is pressed into the open base bottom 12b. The bottom plug 14 also can include ports or weakened areas 20. When espresso is brewed, the brewed beverage escapes from the cartridge 10 through the ports or weakened areas 20, which burst or otherwise open due to the pressure or raised temperature experienced during the brewing process. The weakened area 20 help seal the cartridge 10 before use, so that brewing material can be retained prior to brewing. The bottom plug 14 also can include a guide hole 26 or indentation. The guide hole 26 engages a guide hole pin 52 (see FIG. 17A) to hold the bottom plug during assembly of the cartridge 10. In alternative embodiments, the guide hole 26 and the guide hole pin 52 can be swapped between these two components, or different corresponding guide structures can be used to align the bottom plug 14.

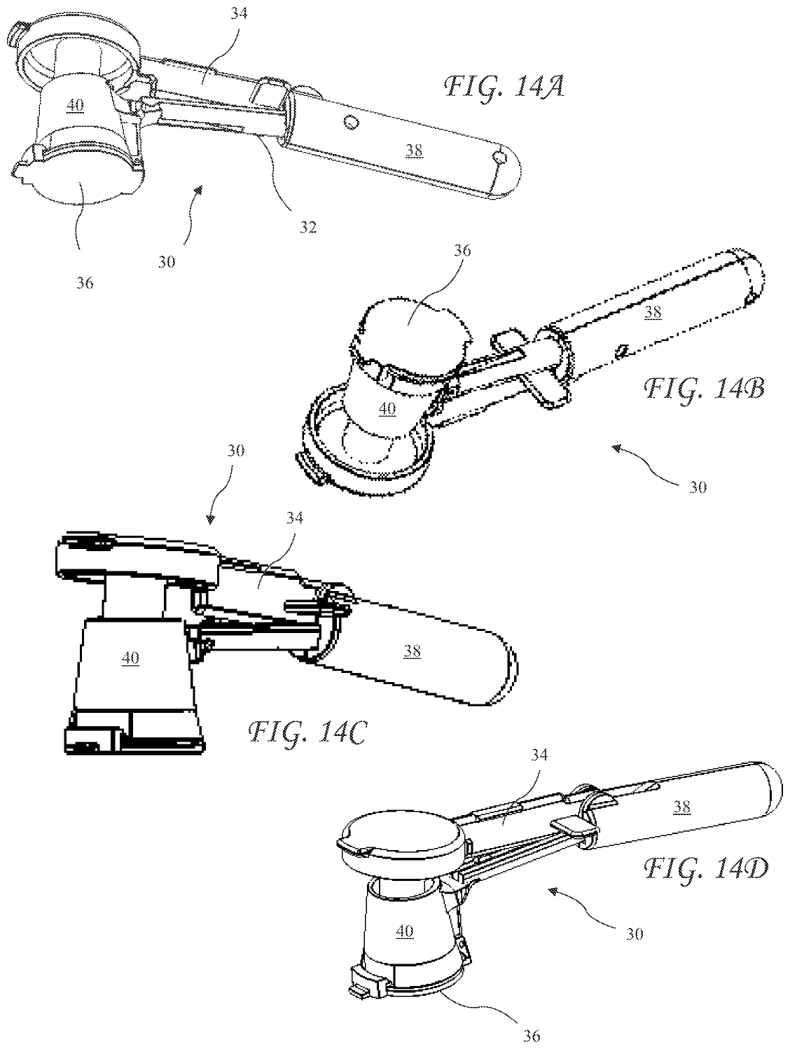

Referring to FIGS. 14A-14D, the cartridge tool 30 includes a frame 32, a handle 38 attached to the frame 32 for grasping by a user, a cartridge holder 40, a cartridge hole lid 36, and a tamper/seater 34. The cartridge base 12 is held in the cartridge holder 40 to fill, tamp, and plug the cartridge 12 to construct an espresso cartridge 10.

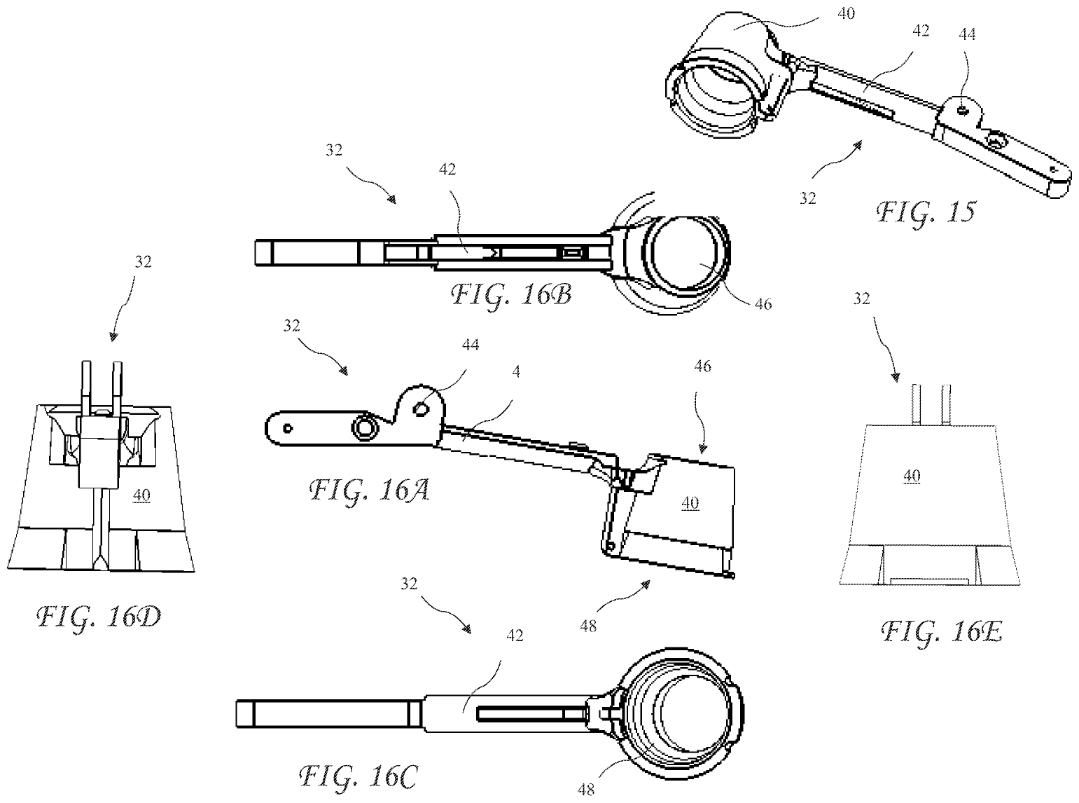

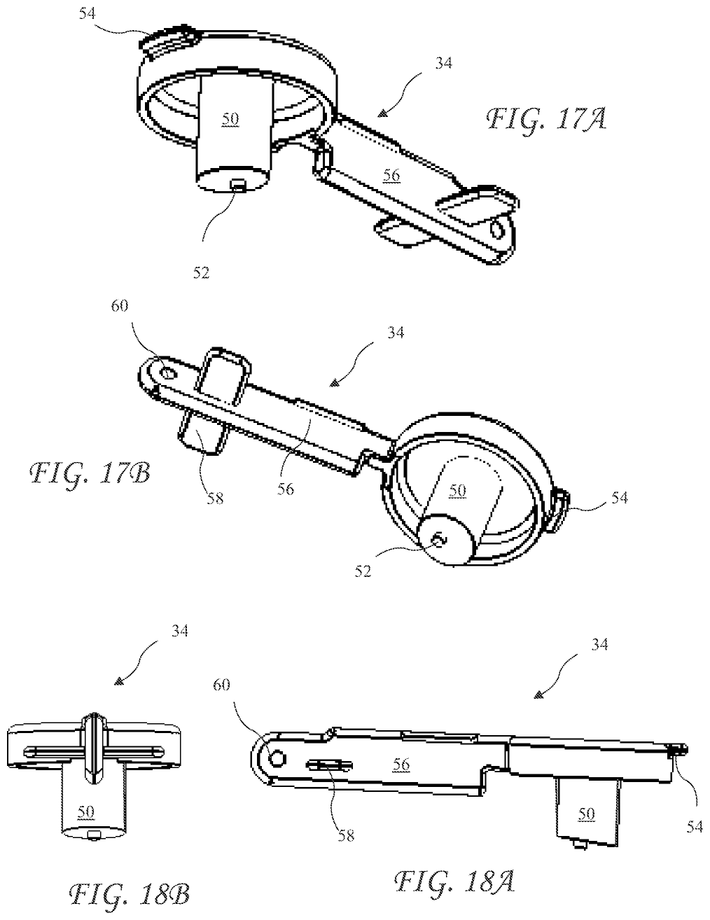

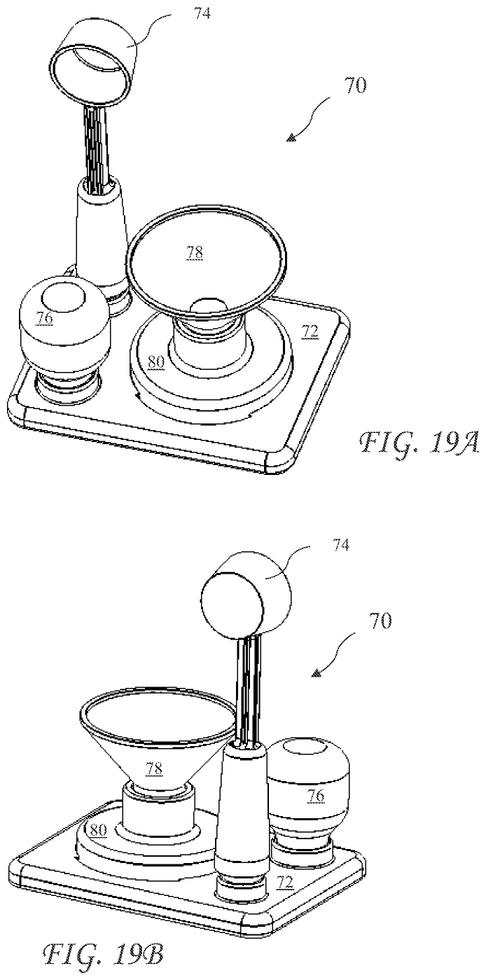

Referring to FIGS. 15-16E, the frame 32 includes the cartridge holder 40, an arm 42 expending from the cartridge holder 40 to the handle 38, and pivot hands 44. The cartridge holder 40 has an open scoop mouth 46 and an open cartridge mouth 48, which can be closed by the lid 36 after placing the cartridge base 12 in the cartridge holder 40. The cartridge holder 40 can have a cylindrical, frustoconical, or other shaped exterior, but preferably has an interior matching or at least accommodating the walls 12c of the cartridge base 12.

Referring to FIGS. 17A-18B, the tamper/seater 34 provides a mechanism for performing steps of making the espresso cartridge 10. A pivot 60 cooperates with the pivot hands 44 of the frame 32, allowing the tamper/seater 34 to pivot toward and away from the cartridge holder 40. A tamping plunger 50 is pushed into the cartridge holder 40 to tamp brewing material held in the cartridge base 12. After tamping, the tamping plunger 50 is used to press the bottom plug 14 into the cartridge base 12. The tamping plunger 50 can include the guide hole pin 52 to attach the bottom plug 14 to the tamping plunger 50 to hold the bottom plug 14 aligned with the cartridge base bottom 12b while pressing the bottom plug 14 into the cartridge base bottom 12b. The tamper/seater 34 can include wings 58 or other implements configured to facilitate one-handed operation of the tool 30. A tamper arm 56 connects the pivot 60 to the tamper plunger 50.

Referring to FIGS. 19A and 19B, the countertop tool includes a tool base 72, a cartridge lock 80 configured to retain the cartridge base 12 on the tool base 72, a funnel 78 that can be used when filling the cartridge base 12, a scoop and tamper 74 combination configured to measure and pour brewing material, and a seating tool 76 that can be used to seat the bottom plug after filling the cartridge base 12 with the brewing material.

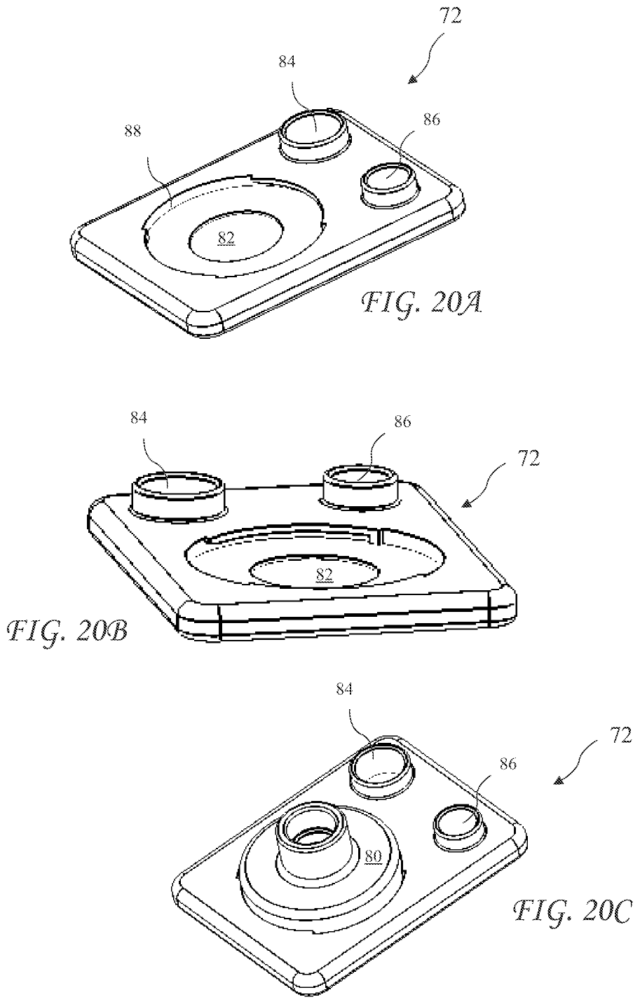

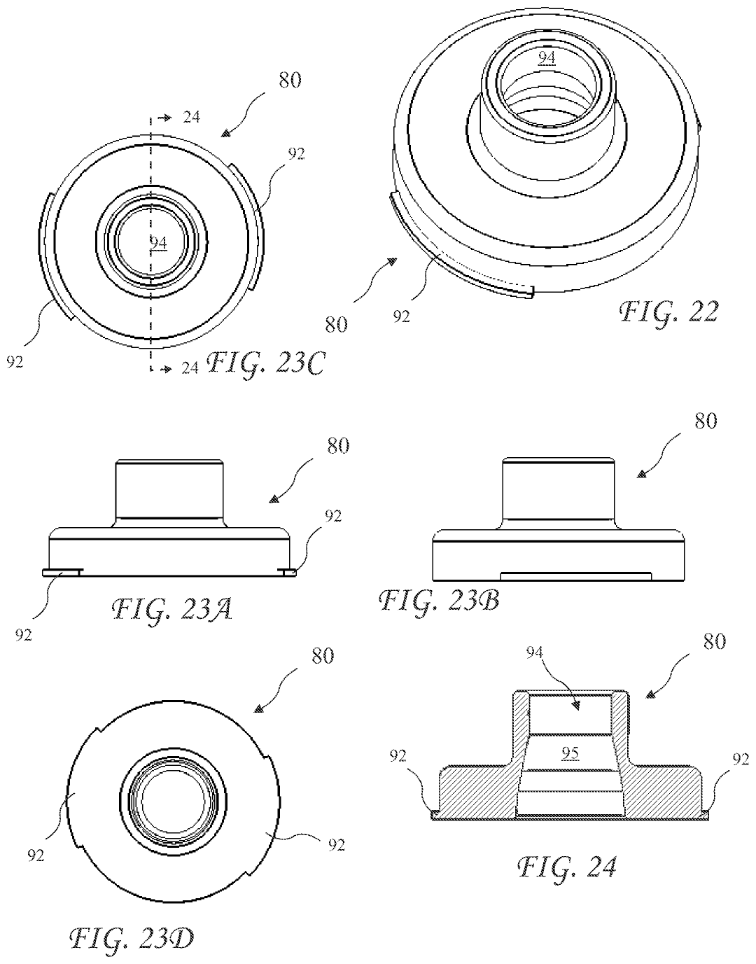

Referring to FIGS. 20A-20C, the tool base 72 includes a cartridge seat 82 that is slightly larger than the cartridge top 12a to position the cartridge 12 on the tool base 72. Locking recesses 88 are formed around the cartridge seat 82 to attach a cartridge lock 80 (see FIGS. 22-24) to the tool base 72 to hold the cartridge base 12 on the tool base 71. A recess 84 is formed on the tool base 72 to position or store the seating tool 76 when not in use and a recess 86 is formed to position or store the scoop and tamper 74 when not in use.

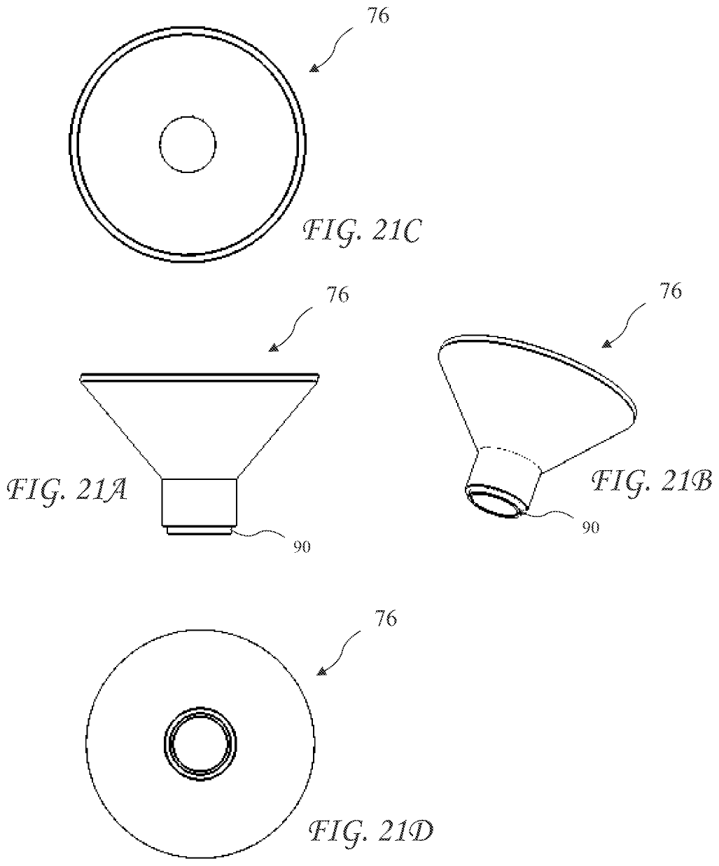

Referring to FIGS. 21A-D, the funnel 76 fits into a cylindrical access mouth 94 (see FIG. 24) of the cartridge lock 80. The funnel 76 can include a step 90 to align the funnel with the open base bottom 12b, or can be tapered to align the funnel with the open base bottom 12b.

Referring to FIGS. 22-24, an exemplary cartridge lock 80 includes locking ring segments 92 that engage the locking recesses 88 of the tool base 72 to retain the cartridge lock 80 and the cartridge base 12 on the tool base 72. The cartridge lock 80 includes an interior 95 shaped to position the cartridge base in the cartridge lock 80 when filling with and tamping brewing material, and when seating the bottom plug 14.

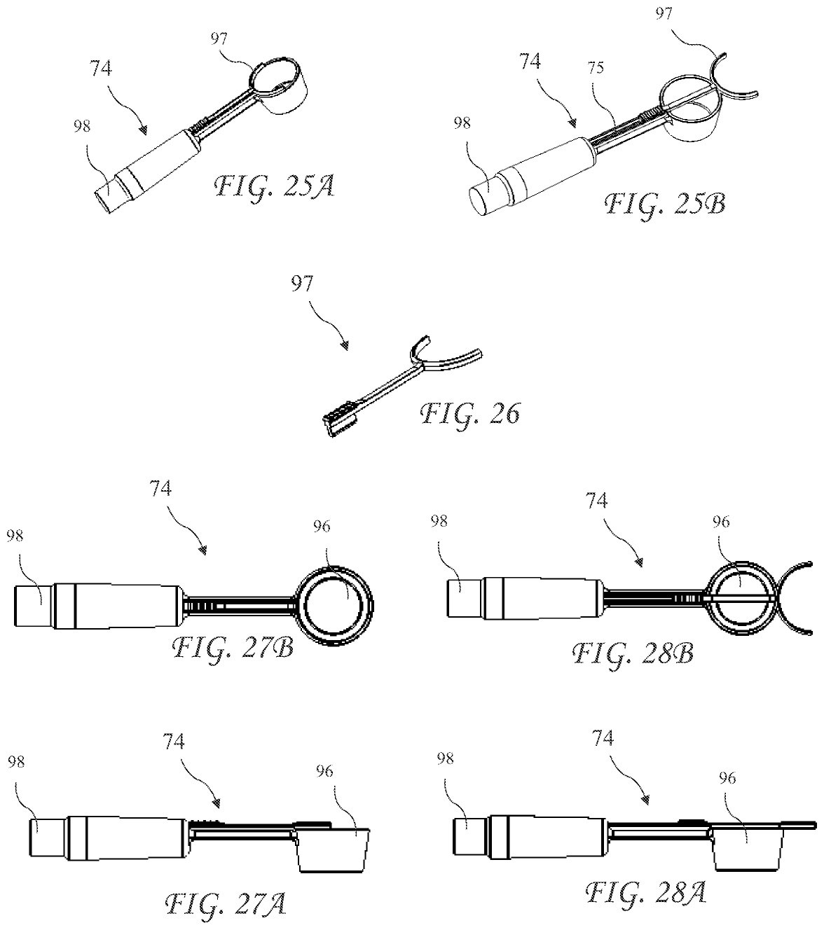

Referring to FIGS. 25A-26, the scoop and tamper combination tool 74 includes a leveling bar or fork 97 that is restrained to slide in a slot 75 in the scoop and tamper tool 74. After scooping a portion of brewing material 11 (see FIG. 4), the leveling fork 97 can be guided forward to push excess brewing material off the scoop and tamper tool 74 to obtain a consistent measured amount of brewing material 11.

The scoop and tamper tool 74 includes a tamper 98, which can be, for example, cylindrical and a preferably flat tamping end 51 opposite the scoop 96. The tamper 98 is slightly smaller in diameter than the cylindrical access mouth 94 of the cartridge lock 80 to allow the cylindrical tamper 98 to pass through the cylindrical mouth 94 during tamping. The combination tool 74 includes both the scoop and the tamper for convenience.

Referring to FIGS. 27A-28B, sliding of the leveling bar or fork 97 across the mouth of the scoop is shown. The leveling bar or fork 97 extends on an arm that can be biased to return the leveling bar or fork 97 to the retracted position. The end of the leveling bar or fork 97 is shown to be rounded to correspond to the shape of the mouth of the scoop, but both the scoop and the end of the leveling bar or fork 97 can take any shape and need not mutually correspond except to the extent that the end of the leveling bar or fork 97 can retract so as not to interfere with scooping, and can extend to push all excess brewing material from above the mouth of the scoop.

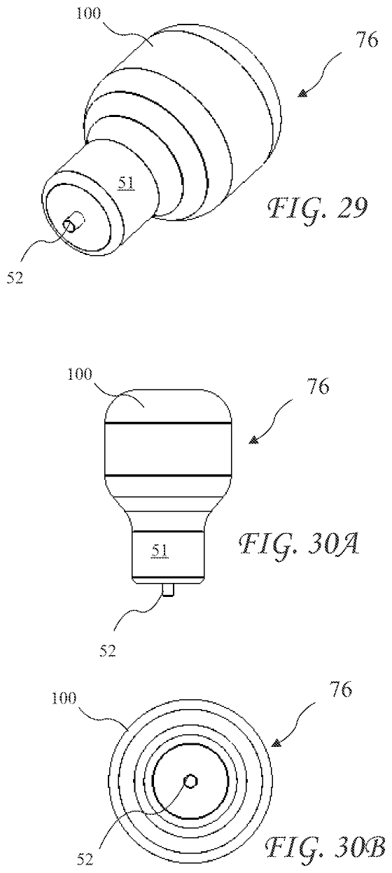

Referring to FIGS. 29-30B, the seating tool 76 includes a cylindrical portion 51 extending from a grasping portion 100. The grasping portion 100 facilitates applying a force required to seat the bottom plug 14 in the open cartridge bottom 12b. A guide hole pin 52 is included to attach the bottom plug 14 to the seating tool 76 in order to hold the bottom plug 14 in alignment with the cartridge base bottom 12b while pressing the bottom plug 14 into the cartridge base bottom 12b.

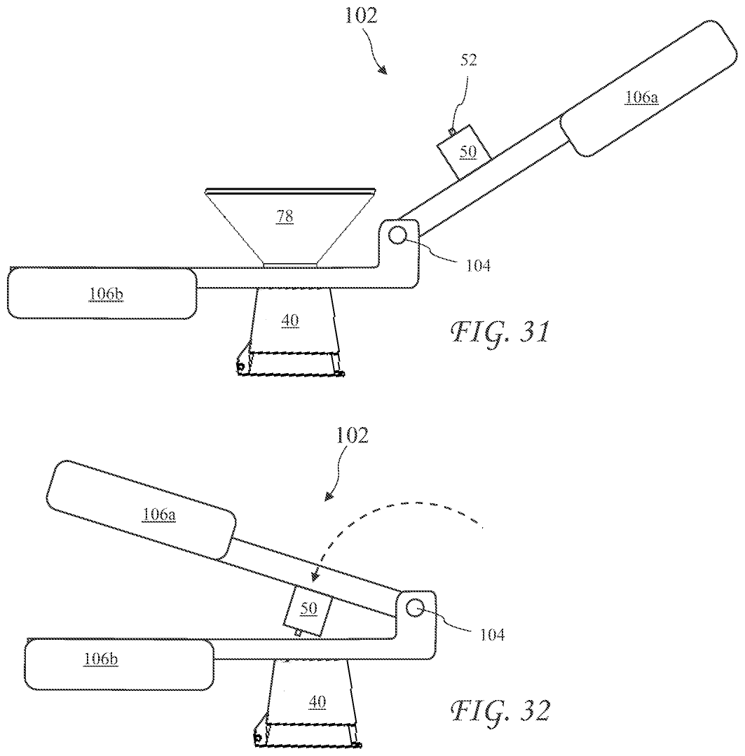

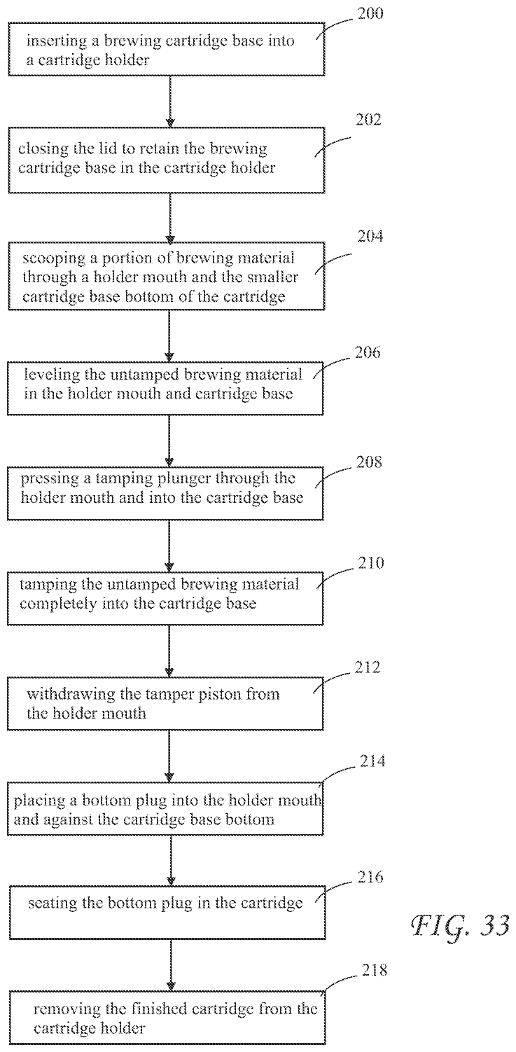

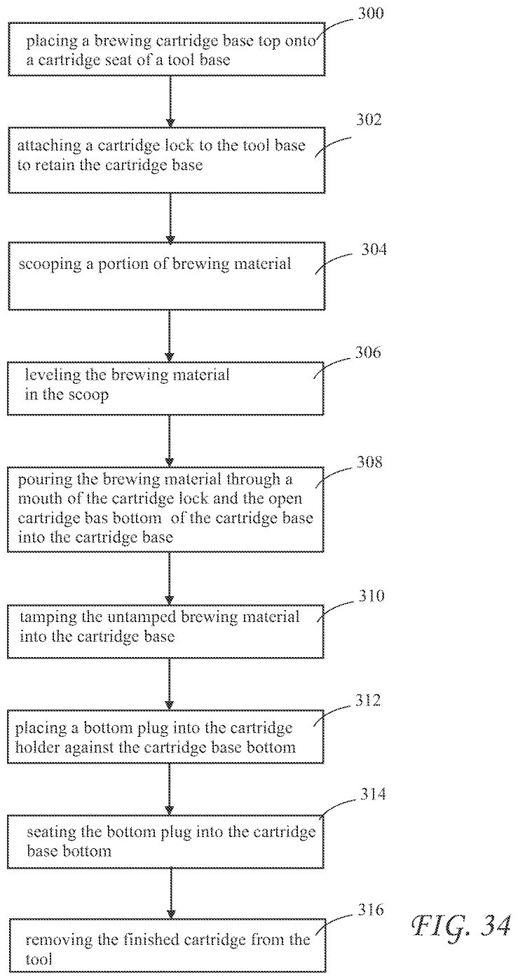

Referring to FIGS. 31 and 32, the tool 102 includes a pivot 104 and handles 106a and 106b. The cartridge holder 40 is fixed to one handle 106b, and the tamper plunger 50 is attached to the handle 106a. The cartridge base 12 can be filled using the scoop and tamper 74 as described for the tool 70 above, and the handle 106a can be pivoted first to tamp the brewing material using the tamper plunger 50, and then to seat the bottom plug 14 using the tamper plunger 50, as described for the tool 30 above. The tool 102 advantageously provides leverage during tamping and seating, making it easier to use the tool.

Referring to FIG. 33, an exemplary method according to the invention for using the hand-held tool includes inserting a cartridge base into a cartridge holder, an open cartridge base bottom first into the cartridge holder, the cartridge base bottom diameter smaller than a cartridge base top opposite to the cartridge base bottom at step 200, closing a lid to retain the cartridge base in the cartridge holder at step 202, scooping a portion of untamped brewing material through a holder mouth and the smaller cartridge base bottom of the cartridge at step 204, leveling the untamped brewing material in the holder mouth and cartridge base at step 206, pressing a tamping plunger through the holder mouth and into the cartridge holder at step 208, tamping the untamped brewing material completely into the cartridge base at step 210, withdrawing the tamper piston from the holder mouth at step 212, placing a bottom plug into the holder mouth and against the smaller cartridge base bottom of the cartridge base at step 214, seating the bottom plug in the smaller base bottom of the cartridge at step 216, and removing the finished cartridge from the cartridge holder at step 218.

Referring to FIG. 34, an exemplary method according to the invention for using the table-top tool includes placing a brewing cartridge base onto a cartridge seat of a tool base, a closed cartridge base top against the cartridge seat, the cartridge base top having a larger diameter than an open cartridge base bottom opposite the cartridge base top at step 302, attaching a cartridge lock to the tool base to retain the cartridge base against the tool base at step 302, scooping a portion of brewing material at step 304, leveling the brewing material in the scoop at step 306, pouring the brewing material through a mouth of the cartridge lock and the open bottom end of the cartridge base, into the cartridge base at step 308, tamping the untamped brewing material into the cartridge base at step 310, placing a bottom plug into the cartridge holder against the small end of the cartridge at step 312, seating the bottom plug into the cartridge base at step 314, and removing the finished cartridge from the tool at step 316.

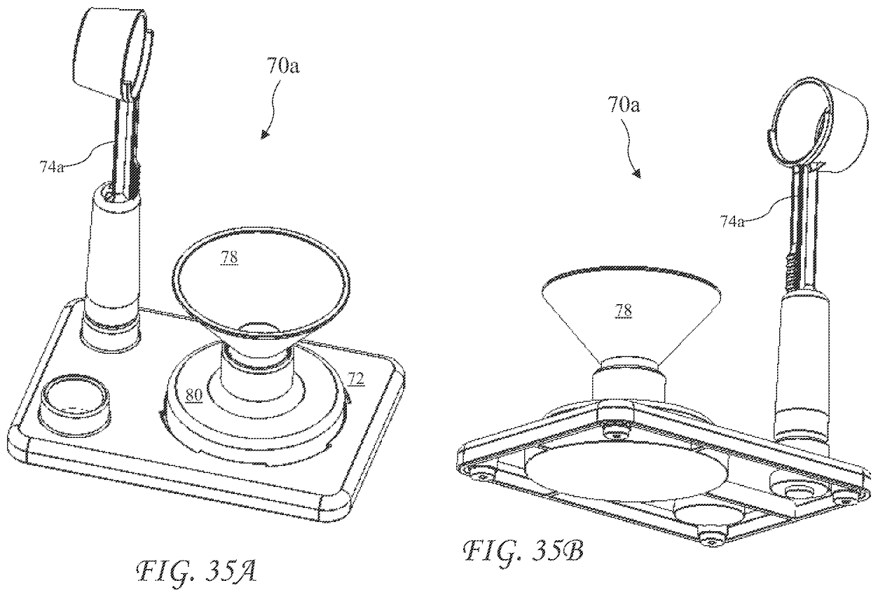

Referring to FIGS. 35A and 35B, an exemplary countertop tool 70a includes a combination scoop/tamper/seating tool 74a replacing the scoop and tamper 74, and does not include the dedicated seating tool 76.

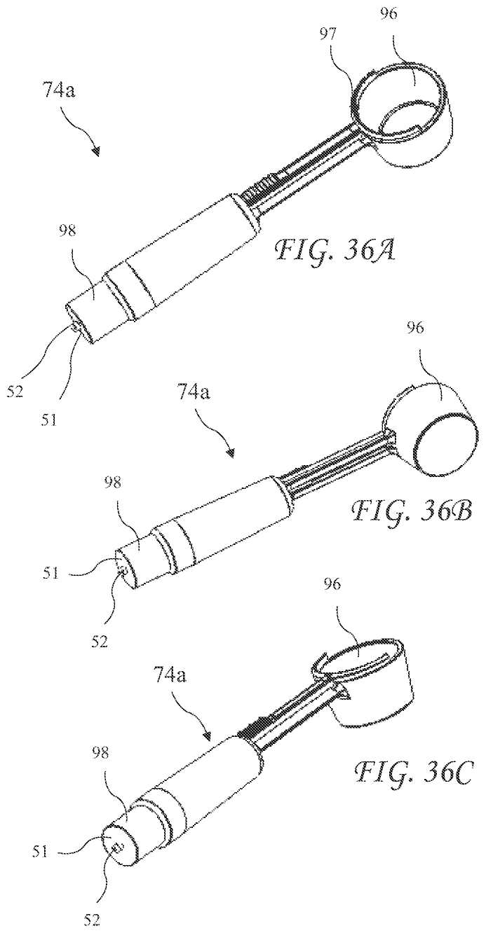

Referring to FIGS. 36A-36C, the exemplary scoop/tamper/seating tool 74a is similar to the scoop and tamper 76, but includes a flat end 51 opposite the scoop 96, and a guide hole pin 52 centered on the flat end 51.

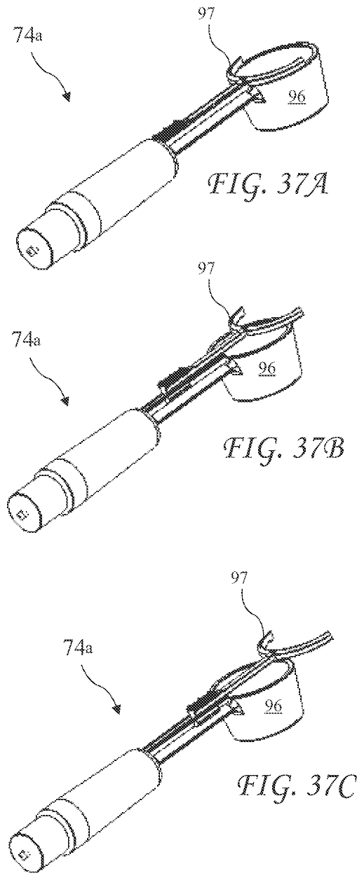

Referring to FIGS. 37A-37C, after scooping brewing material from a bulk brewing material container, the sliding level can be used to level the brewing material to obtain a preferred amount of brewing material for an espresso cartridge. While sliding level 97 is shown in FIGS. 37A-37C, a pivoting level can be used instead, and any apparatus usable to slide over the scoop 96 to level the brewing material is intended to be included within the scope of the invention.

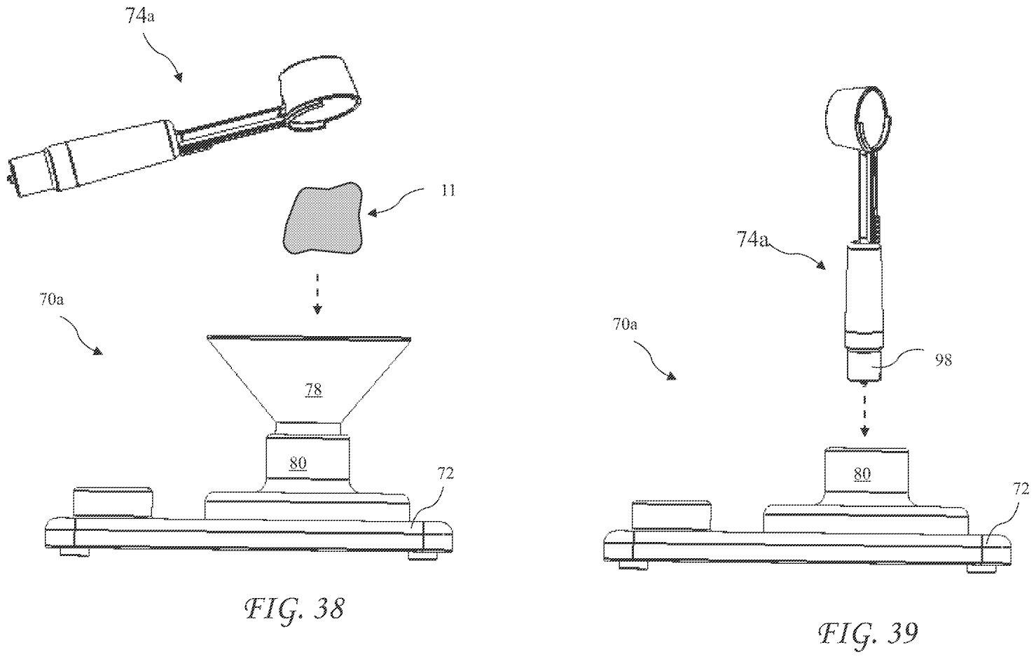

Referring to FIG. 38, the funnel 78 can be fitted to the cartridge lock to guide the brewing material 11 into the cartridge 10 (see FIGS. 1-8) locked to the tool base 72.

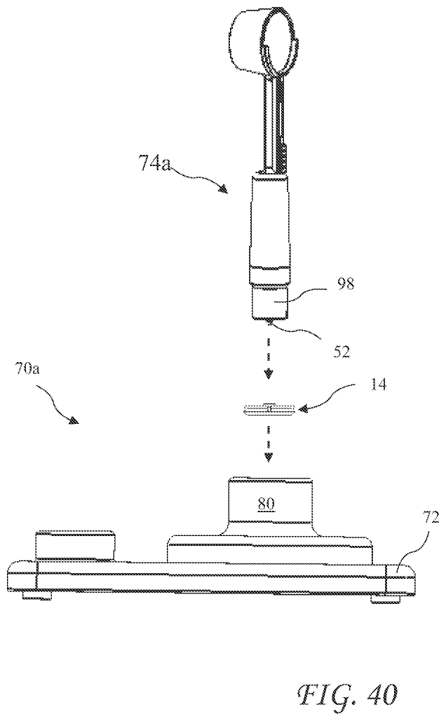

Referring to FIGS. 39 and 40, the scoop/tamper/seating tool 74a includes a cylindrical tamper portion 98 slightly smaller than the cylindrical access mouth 94 (see FIG. 24) of the cartridge lock 80 to allow the cylindrical tamper portion 98 to enter the cartridge.

The scoop/tamper/seating tool 74a is shown positioned to seat the bottom plug 14 in the espresso cartridge 10 retained by the cartridge lock 80 in the tool base 72. The guide hole pin 52 engages the guide hole 21 of the bottom plug 14 and the cylindrical tamper portion 98 centers the bottom plug 14 for seating in the espresso cartridge 10.

Generally, according to an aspect of the invention, a beverage brewing cartridge includes a cartridge base, and a cartridge plug. The cartridge base includes a sidewall, a fillable end having an opening, and a closed end. The cartridge plug is configured to close off the opening of the fillable end of the cartridge base. Thus, the empty cartridge base is configured to be filled through the opening in the fillable end, which can then be closed off to form the beverage brewing cartridge.

The cartridge base sidewall can be, for example, cylindrical or frustoconical in shape, or can take any shape, for both the inside and outside surfaces of the sidewall, which can be the same or different. The closed end of the cartridge base can be integrally closed or closed by a lid, or sealed, for example, with foil. The cartridge plug can include ports configured to allow fluid to flow from the cartridge. For example, the ports can include weakened areas configured to burst under pressure or when in contact with heated liquid, thereby allowing fluid to flow from the cartridge. The cartridge plug and the opening of the fillable end of the cartridge base can include a recess and a corresponding mating ridge, which can be annular if the plug and opening are round or rounded. The beverage brewing cartridge can also include a peripheral lip above the recess. The lip can include gaps configured to allow the lip to collapse during insertion of the cartridge plug into the opening of the tillable end of the cartridge base, providing a press-fit coupling.

According to another aspect of the invention, a method of constructing a brewing cartridge includes placing the cartridge base of the beverage brewing cartridge on a cartridge seat of a cartridge tool with the closed end of the cartridge base against the cartridge seat. The cartridge base is retained against the cartridge tool using, for example, a cartridge lock. A portion of brewing material is scooped and poured into the cartridge base through a mouth of the cartridge lock and the opening of the fillable end of the cartridge base. The brewing material is then tamped into the cartridge base. The cartridge plug is positioned above and aligned with the opening of the fillable end of the cartridge base. The cartridge plug is then seated into the opening of the fillable end of the cartridge base to close the opening of the fillable end of the cartridge base, thereby completing construction of the brewing cartridge. The method can also include releasing the cartridge lock from the cartridge base, and removing the brewing cartridge from the cartridge tool.

Scooping the portion of brewing material and tamping the brewing material into the cartridge base can include using a combination scooping/tamping tool. To provide a measured portion of brewing material, the method can also include leveling the portion of brewing material using a leveling arm of the combination scooping/tamping tool, prior to pouring the scooped brewing material. This leveling arm can take any shape.

Positioning the cartridge plug above and aligned with the opening of the fillable end of the cartridge base can include engaging a first guide element on the cartridge plug with a second guide element on an end of the combination scooping/tamping tool, and inserting the end of the combination scooping/tamping tool into an access mouth of the cartridge lock. These guide elements can take the form of any mating structures, such as a corresponding indentation or hole and pin.

The method can also include, prior to placing the cartridge base on the cartridge seat of the cartridge tool, obtaining the cartridge base, and sealing an end of the cartridge base to form the closed end of the brewing cartridge base. For example, sealing the end of the cartridge base can include applying foil to the end of the brewing cartridge base. Alternatively, a cover can be coupled to the cartridge base to close the end. Seating the cartridge plug into the opening of the fillable end of the cartridge base can include engaging a ridge into a recess. Alternatively, these elements can be screwed together, friction fit, or coupled in any other suitable manner.

According to another aspect of the invention, a beverage brewing cartridge construction kit, configured to construct a brewing cartridge, includes the cartridge tool and the cartridge lock. The cartridge tool can include a cartridge seat. The beverage brewing cartridge construction kit can also include a combination scooping/tamping tool. The combination scooping/tamping tool can include a scoop and a tamper, as well as a levelling arm and/or a cartridge plug guide element.

The invention has been described by way of example and in terms of preferred embodiments. However, the present invention as contemplated by the inventor is not strictly limited to the particularly disclosed embodiments. To the contrary, various modifications, as well as similar arrangements, are included within the spirit and scope of the present invention. The scope of the appended claims, therefore, should be accorded the broadest reasonable interpretation so as to encompass all such modifications and similar arrangements.

I claim:

1. A beverage brewing cartridge, comprising:
a cartridge base; and
a cartridge plug;
wherein the cartridge base includes a sidewall, a fillable end having an opening, and a closed end; and
wherein the cartridge plug is configured to close off the opening of the fillable end of the cartridge base.

2. The beverage brewing cartridge of claim 1, wherein the cartridge base sidewall is frustoconical in shape.

3. The beverage brewing cartridge of claim 1, wherein the closed end of the cartridge base is sealed with foil.

4. The beverage brewing cartridge of claim 1, wherein the cartridge plug includes ports configured to allow fluid to flow from the cartridge.

5. The beverage brewing cartridge of claim 4, wherein the ports include weakened areas configured to burst under pressure, thereby allowing fluid to flow from the cartridge.

6. The beverage brewing cartridge of claim 1, wherein:
one of the cartridge plug and the opening of the fillable end of the cartridge base includes an annular recess; and
another of the cartridge plug and the opening of the fillable end of the cartridge base includes a corresponding annular ridge;
wherein the annular recess and the annular ridge are configured for mutual mating contact.

7. The beverage brewing cartridge of claim 6, further comprising a circumferential lip above the annular recess, wherein the circumferential lip includes gaps configured to allow the circumferential lip to collapse during insertion of the cartridge plug into the opening of the fillable end of the cartridge base.

8. A method of constructing a brewing cartridge, comprising:
placing the cartridge base of the beverage brewing cartridge of claim 1 on a cartridge seat of a cartridge tool with the closed end of the cartridge base against the cartridge seat;
retaining the cartridge base against the cartridge tool using a cartridge lock;
scooping a portion of brewing material;
pouring the scooped brewing material into the cartridge base through a mouth of the cartridge lock and the opening of the fillable end of the cartridge base;
tamping the brewing material into the cartridge base;
positioning the cartridge plug above and aligned with the opening of the fillable end of the cartridge base;
seating the cartridge plug into the opening of the fillable end of the cartridge base to close the opening of the fillable end of the cartridge base, thereby completing construction of the brewing cartridge.

9. The method of claim 8, further comprising:
releasing the cartridge lock from the cartridge base; and
removing the brewing cartridge from the cartridge tool.

10. The method of claim 8, wherein scooping the portion of brewing material and tamping the brewing material into the cartridge base includes using a combination scooping/tamping tool.

11. The method of claim 10, further comprising leveling the portion of brewing material using a leveling arm of the combination scooping/tamping tool, prior to pouring the scooped brewing material.

12. The method of claim 8, wherein positioning the cartridge plug above and aligned with the opening of the fillable end of the cartridge base includes:
engaging a first guide element on the cartridge plug with a second guide element on an end of the combination scooping/tamping tool; and
inserting the end of the combination scooping/tamping tool into an access mouth of the cartridge lock.

13. The method of claim 8, further comprising, prior to placing the cartridge base on the cartridge seat of the cartridge tool:
obtaining the cartridge base; and
sealing an end of the cartridge base to form the closed end of the brewing cartridge base.

14. The method of claim 13, wherein sealing the end of the cartridge base includes applying foil to the end of the brewing cartridge base.

15. The method of claim 8, wherein seating the cartridge plug into the opening of the fillable end of the cartridge base includes engaging a ridge into a recess.

16. A beverage brewing cartridge construction kit, configured to construct a brewing cartridge according to the method of claim 8, comprising:
the cartridge tool; and
the cartridge lock.

17. The beverage brewing cartridge construction kit of claim 16, wherein the cartridge tool includes a cartridge seat.

18. The beverage brewing cartridge construction kit of claim 16, further comprising a combination scooping/tamping tool.

19. The beverage brewing cartridge construction kit of claim 18, wherein the combination scooping/tamping tool includes a levelling arm.

20. The beverage brewing cartridge construction kit of claim 18, wherein the combination scooping/tamping tool includes a cartridge plug guide element.
